(19) United States
(12) Patent Application Publication
(10) Pub. No.: US 2023/0318445 A1
(43) Pub. Date: Oct. 5, 2023

(54) AUTOMOTIVE DC-DC POWER CONVERTER WITH FLYBACK CONVERTER FOR INPUT CAPACITOR CHARGING

(71) Applicant: Ford Global Technologies, LLC, Dearborn, MI (US)

(72) Inventors: Nicholas B. Chase, Royal Oak, MI (US); William Frederick Sanderson, JR., Commerce Twp., MI (US)

(21) Appl. No.: 17/711,630

(22) Filed: Apr. 1, 2022

(51) Int. Cl. H02M 1/36; B60L 58/20; H02J 7/00; H02M 3/335

(52) U.S. Cl. CPC H02M 1/36; B60L 58/20; H02J 7/0019; H02M 3/33507; H02J 2207/20; H02M 1/322

(57) ABSTRACT

A DC-DC power converter selectively electrically connected between a fuel cell stack and battery of a vehicle includes an input capacitor, an output capacitor, and an inductor electrically connected between the input and output capacitors. A flyback converter is isolated from the DC-DC power converter. One or more controllers operate the flyback converter to drive a voltage value of the input capacitor toward a voltage value of the fuel cell stack.

### TECHNICAL FIELD

This disclosure relates to power systems for vehicles.

### BACKGROUND

An alternatively powered vehicle may include a fuel cell to generate electricity for consumption by electric machines and/or other devices of the vehicle. The fuel cell may be selectively electrically connected with a high voltage bus as needed.

### SUMMARY

A power system for a vehicle includes a fuel cell stack, a battery, and a DC-DC power converter selectively electrically connected between the fuel cell stack and battery via activation of switches. The DC-DC power converter includes an input capacitor, an output capacitor, and an inductor electrically connected between the input and output capacitors. The switches are electrically connected between the fuel cell stack and input capacitor. The power system also includes an isolated flyback converter including a winding in parallel with the input capacitor. The flyback converter drives a voltage value of the input capacitor toward a voltage value of the fuel cell stack prior to the switches being operated to electrically connect the fuel cell stack and battery.

A method includes operating a flyback converter isolated from a DC-DC power converter that is electrically connected with a battery to charge an input capacitor of the DC-DC power converter such that a voltage value of the input capacitor approaches a voltage value of a fuel cell stack. The method also includes, after a difference in the voltage values falls within a predefined range, operating switches that are electrically connected between the input capacitor and fuel cell stack to electrically connect the fuel cell stack with the battery.

A power system for a vehicle includes a DC-DC power converter selectively electrically connected between a fuel cell stack and battery of the vehicle, and including an input capacitor, an output capacitor, and an inductor electrically connected between the input and output capacitors. The power system also includes a flyback converter isolated from the DC-DC power converter, and one or more controllers that operate the flyback converter to drive a voltage value of the input capacitor toward a voltage value of the fuel cell stack.

### BRIEF DESCRIPTION OF THE DRAWINGS

FIG. 1 is a schematic diagram of a power system for a vehicle including an isolated flyback converter.

FIG. 2 is a schematic diagram of a power system for a vehicle including a control unit.

FIG. 3 is a schematic diagram of a power system for a vehicle including a pre-charge resistor.

FIG. 4 is a schematic diagram of a power system for a vehicle including a buck converter.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

For fuel cell systems that are not capable of load following, a high voltage (HV) battery should be used to supplement power during peak load conditions and/or charging of the HV battery. Therefore, the fuel cell stack and HV battery should both supply power to the same HV bus. To match the output voltage of the fuel cell stack to battery voltage, a HV to HV direct current (DC)-DC unidirectional boost converter is used.

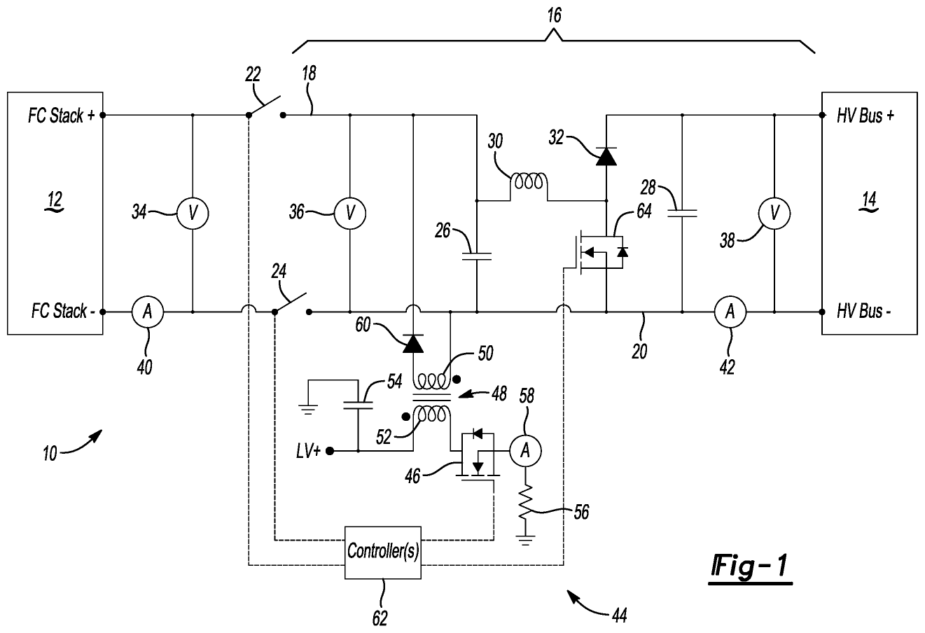

Referring to FIG. 1, an example power system 10 for a vehicle includes a fuel cell stack 12, a high voltage battery 14, and a fuel cell HV to HV DC-DC converter 16 electrically connected therebetween. The DC-DC converter 16 includes a positive rail 18, a negative rail 20, switches 22, 24 (e.g., contactors, etc.), an input capacitor 26, an output capacitor 28, an inductor 30, and a diode 32. When the switches 22, 24 are closed, the input capacitor 26 is in parallel with the fuel cell stack 12. The inductor 30 and diode 32 are on the positive rail 18 and are electrically connected between the input and output capacitors 26, 28. The output capacitor 28 is in parallel with the high voltage battery 14.

The power system 10 also includes voltage sensors 34, 36, 38 and current sensors 40, 42. The voltage sensors 34, 36 are electrically connected between the fuel cell stack 12 and high voltage battery 14, on either side of the switches 22, 24. The voltage sensor 34 is in parallel with the fuel cell stack 12, and when the switches 22, 24 are closed, the voltage sensor 36 is in parallel with the input capacitor 26 (and fuel cell stack 12). The voltage sensor 38 is electrically connected between, and in parallel with, the high voltage battery 14 and output capacitor 28. The current sensor 40 is on the negative rail 20 between the fuel cell stack 12 and switch 24. The current sensor 42 is on the negative rail 20 between the output capacitor 28 and high voltage battery 14.

During startup of the vehicle, the HV bus is pre-charged to battery voltage using a pre-charge method implemented in the battery system. The diode 32 between the low-side positive and high-side positive of the DC-DC converter 16 prevents the input capacitor 26 from charging along with the output capacitor 28 and the other HV bus capacitances.

The HV capacitors 26, 28, in certain circumstances, are required by regulatory requirements to be discharged within 60 seconds so at startup the input capacitor 26 will typically be at low voltage. Closing the switches 22, 24 prior to fuel cell stack startup (i.e., fuel cell stack voltage equal to 0V) will cause the input capacitor 26 to put a load on the fuel cell stack 12 during startup. Loads on fuel cells during startup can result in individual cell voltage reversals that can cause fuel cell degradation resulting in reduced service life. Therefore, it may be better for fuel cell durability to wait to close the switches 22, 24 until the fuel cell stack 12 starts flowing reactants and all the cells are ready to supply current.

With the switches 22, 24 open and the input capacitor 26 discharged, there can be a large voltage across the switches 22, 24 at the time the fuel cell stack 12 is ready to supply current. In order to close the switches 22,24, the voltage across them can be controlled to a relatively small voltage to prevent premature issues, and to prevent welding issues, caused by large inrush currents at switch closure. Therefore, a method for pre-charging the input capacitor 26 prior to switch closure may be useful.

A small low voltage (LV) to HV DC-DC flyback converter 44 can added to the HV to HV DC-DC converter design that converts vehicle LV power to a HV output that can be used to charge the input capacitor 26 prior to closing the switches 22, 24. By pre-charging the input capacitor 26 using the flyback converter 44 prior to closing the switches 22, 24, the fuel cell stack 12 may build up voltage without the input capacitor load and prepare to supply current before switch closure. With the input capacitor 26 charged to closely match the fuel cell stack voltage, the switches 22, 24 can be closed with very small inrush currents, which removes the possibility of having fuel cell voltage reversals.

The flyback converter 44, in this example, includes a switch 46 (e.g., a metal-oxide-semiconductor field-effect transistor (MOSFET)), a transformer 48 that isolates the HV and LV buses and is comprised of a LV winding 50 and a HV winding 52, a LV input capacitor 54, a sense resistor 56, a current sensor 58, and a diode 60 on the HV side to prevent discharge current through the HV winding 50. The switch 46 is controlled by a controller 62 to match the voltage of the input capacitor 26 to the voltage of the fuel cell stack 12. The controller 62 uses data from the current sensor 58, voltage sensor 34, and voltage sensor 36 to measure the voltage of the input capacitor 26. The output voltage may also be measured using a feedback winding inside the flyback converter 44.

During fuel cell startup, the switches 22, 24 are left open. As the fuel cell stack voltage begins to rise, the controller 62 controls the output voltage of the flyback converter 44, which is the voltage of the input capacitor 26, to match the voltage of the fuel cell stack 12. Once the fuel cell stack 12 has had sufficient time to prepare to supply current, and the input capacitor 26 is charged such that the voltage across the switches 22, 24 is within an allowable threshold (range) that prevents issues associated with the switches 22, 24 and fuel cell stack 12, the switches 22, 24 are closed by the controller 62. Once the switches 22, 24 are closed, the flyback converter 44 is disabled and the converter 16 can start to boost power from fuel cell voltage to HV bus voltage by controlling switching device 64 (e.g., a MOSFET), which is connected between the low voltage rail 20 and a node shared by the inductor 30 and diode 32, with the controller 62.

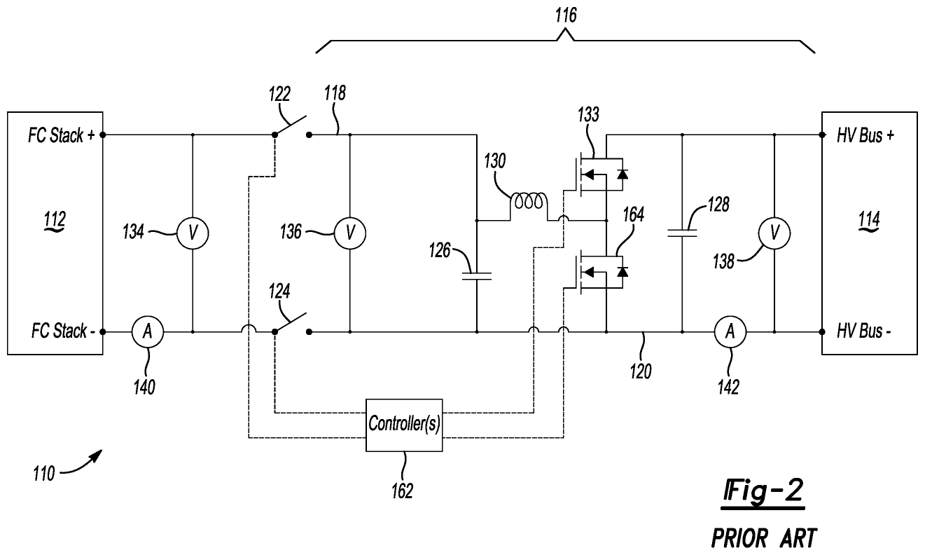

A previous arrangement of a bidirectional DC-DC converter used switching devices (e.g., insulated-gate bipolar transistors (IGBT) or MOSFETs) between the low-side positive and high-side positive, to charge the input capacitor using power from the HV bus. Referring to FIG. 2, a power system 110 for a vehicle includes a fuel cell stack 112, a high voltage battery 114, and a fuel cell HV to HV DC-DC converter 116 electrically connected therebetween. The DC-DC converter 116 includes a positive rail 118, a negative rail 120, switches 122, 124 (e.g., contactors, etc.), an input capacitor 126, an output capacitor 128, an inductor 130, a switch 133, a controller 162, and a switch 164. When the switches 122, 124 are closed, the input capacitor 126 is in parallel with the fuel cell stack 112. The inductor 130 and switch 133 are on the positive rail 118 and are electrically connected between the input and output capacitors 126, 128. The output capacitor 128 is in parallel with the high voltage battery 114.

Voltage sensors 134, 136, 138 and current sensors 140, 142 are also included. The voltage sensors 134, 136 are electrically connected between the fuel cell stack 112 and high voltage battery 114, on either side of the switches 122, 124. The voltage sensor 134 is in parallel with the fuel cell stack 112, and when the switches 122, 124 are closed, the voltage sensor 136 is in parallel with the input capacitor 126 (and fuel cell stack 112). The voltage sensor 138 is electrically connected between, and in parallel with, the high voltage battery 114 and output capacitor 128. The current sensor 140 is on the negative rail 120 between the fuel cell stack 112 and switch 124. The current sensor 142 is on the negative rail 120 between the output capacitor 128 and high voltage battery 114.

This arrangement can be attractive given the availability of off the shelf HV to HV bidirectional converters with a separate power distribution unit. The bidirectional function is typically used for large reverse currents such as charging the high voltage battery 114. The reverse current is only needed in fuel cell applications to charge the input capacitor 126.

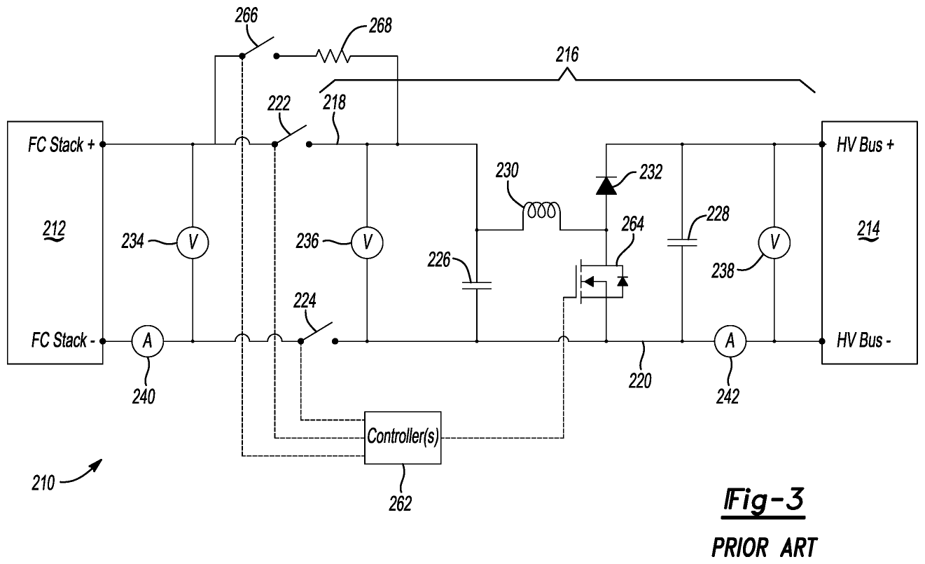

Another previous arrangement has a pre-charge circuit that has a relay and resistor in parallel with the positive switch. The negative switch is closed and then the pre-charge relay is closed. Referring to FIG. 3, a power system 210 for a vehicle includes a fuel cell stack 212, a high voltage battery 214, and a fuel cell HV to HV DC-DC converter 216 electrically connected therebetween. The DC-DC converter 216 includes a positive rail 218, a negative rail 220, switches 222, 224 (e.g., contactors, etc.), an input capacitor 226, an output capacitor 228, an inductor 230, a controller 262, switches 264, 266, and a pre-charge resistor 268 in series with the switch 266. When the switches 222, 224 are closed, the input capacitor 226 is in parallel with the fuel cell stack 212. The inductor 230 and switch 233 are on the positive rail 218 and are electrically connected between the input and output capacitors 226, 228. The output capacitor 228 is in parallel with the high voltage battery 214.

Voltage sensors 234, 236, 238 and current sensors 240, 242 are also included. The voltage sensors 234, 236 are electrically connected between the fuel cell stack 212 and high voltage battery 214, on either side of the switches 222, 224. The voltage sensor 234 is in parallel with the fuel cell stack 212, and when the switches 222, 224 are closed, the voltage sensor 236 is in parallel with the input capacitor 226 (and fuel cell stack 212). The voltage sensor 238 is electrically connected between, and in parallel with, the high voltage battery 214 and output capacitor 228. The current sensor 240 is on the negative rail 220 between the fuel cell stack 212 and switch 224. The current sensor 242 is on the negative rail 220 between the output capacitor 228 and high voltage battery 214.

The pre-charge circuit includes the relay 266 and resistor 268 in series to prevent inrush currents when the relay 266 is closed. In this arrangement, the fuel cell stack power is used to pre-charge the input capacitor 26 to match the voltage of the fuel cell stack 212. Once the input capacitor voltage is within the allowable voltage threshold, the switch 222 is closed.

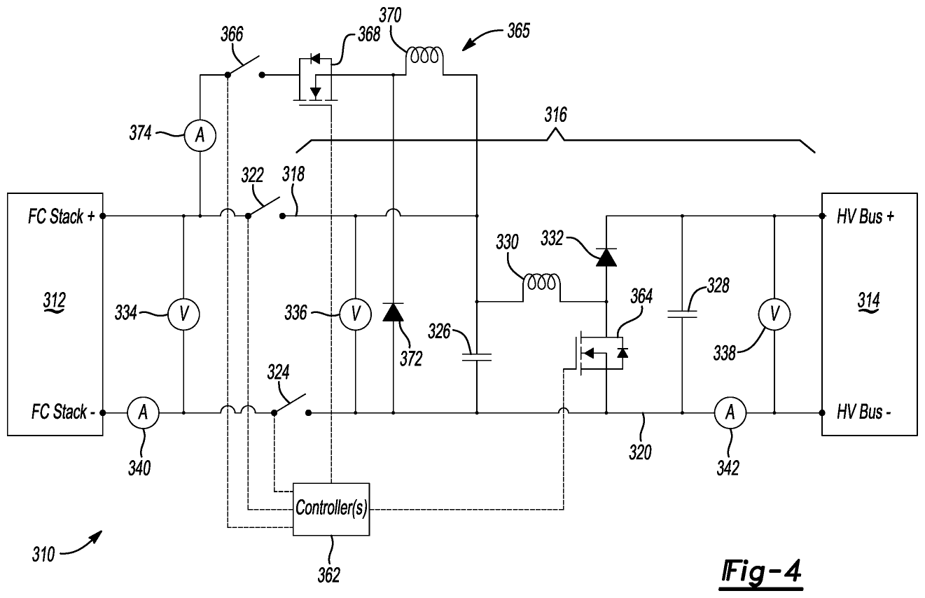

A different power system uses a small HV to HV DC-DC converter across the positive contactor to buck the fuel cell stack voltage down to the input capacitor voltage to pre-charge it to within the allowable voltage threshold for contactor closure. Referring to FIG. 4, a power system 310 for a vehicle includes a fuel cell stack 312, a high voltage battery 314, and a fuel cell HV to HV DC-DC converter 316 electrically connected therebetween. The DC-DC converter 316 includes a positive rail 318, a negative rail 320, switches 322, 324 (e.g., contactors, etc.), an input capacitor 326, an output capacitor 328, an inductor 330, a diode 332, a controller 362, and a switch 364. When the switches 322, 324 are closed, the input capacitor 326 is in parallel with the fuel cell stack 312. The inductor 330 and switch 333 are on the positive rail 318 and are electrically connected between the input and output capacitors 326, 328. The output capacitor 328 is in parallel with the high voltage battery 314.

The DC-DC converter 316 also includes voltage sensors 334, 336, 338 and current sensors 340, 342. The voltage sensors 334, 336 are electrically connected between the fuel cell stack 312 and high voltage battery 314, on either side of the switches 322, 324. The voltage sensor 334 is in parallel with the fuel cell stack 312, and when the switches 322, 324 are closed, the voltage sensor 336 is in parallel with the input capacitor 326 (and fuel cell stack 312). The voltage sensor 338 is electrically connected between, and in parallel with, the high voltage battery 314 and output capacitor 328. The current sensor 340 is on the negative rail 320 between the fuel cell stack 312 and switch 324. The current sensor 342 is on the negative rail 320 between the output capacitor 328 and high voltage battery 314.

A small buck converter 365 can be included. The buck converter 365 includes a switch 366, a field effect transistor 368, an inductor 370, a diode 372, and a current sensor 374. The switch 366 and field effect transistor 368 are series connected. The inductor 370 is connected between the field effect transistor 368 and a node shared by the input capacitor 326 and inductor 330. The diode 372 is connected between a node shared by the field effect transistor 368 and inductor 370 and the negative rail 320. Before closing the switches 322, 324, the switch 326 is closed to charge the input capacitor 326. Once sufficiently charged, the switches 322, 324 can be closed and the switch 366 opened.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words controller and controllers may be interchanged herein. Also, the word switch contemplates contactor(s), field effect transistor(s), and other electrical disconnect devices.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

1. A power system for a vehicle comprising:
a fuel cell stack;
a battery;
a DC-DC power converter configured to be selectively electrically connected between the fuel cell stack and battery via activation of switches, and including an input capacitor, an output capacitor, and an inductor electrically connected between the input and output capacitors, wherein the switches are electrically connected between the fuel cell stack and input capacitor; and
an isolated flyback converter including a winding in parallel with the input capacitor, and configured to drive a voltage value of the input capacitor toward a voltage value of the fuel cell stack prior to the switches being operated to electrically connect the fuel cell stack and battery.

2. The power system of claim 1, wherein the isolated flyback converter includes a field effect transistor and one or more controllers programmed to operate the field effect transistor based on voltage data to drive the voltage value of the input capacitor toward the voltage value of the fuel cell stack.

3. The power system of claim 1 further comprising one or more controllers programmed to, responsive to a difference between the voltage values being within a predefined range, operate the switches to electrically connect the fuel cell stack and battery.

4. The power system of claim 1 further comprising one or more controllers programmed to, responsive to a difference between the voltage values being within a predefined range, disable the isolated flyback converter.

5. The power system of claim 1 further comprising one or more controllers programmed to operate the DC-DC power converter to boost voltage from the fuel cell stack while the isolated flyback converter is disabled.

6. The power system of claim 5, wherein the DC-DC power converter includes a field effect transistor sharing a first node with the inductor and a second node with the output capacitor and wherein the one or more controllers are programmed to operate the DC-DC power converter to boost voltage from the fuel cell stack via selective activation of the field effect transistor.

7. The power system of claim 6, wherein the inductor shares a node with the input capacitor.

8. A method comprising:
operating a flyback converter isolated from a DC-DC power converter that is electrically connected with a battery to charge an input capacitor of the DC-DC power converter such that a voltage value of the input capacitor approaches a voltage value of a fuel cell stack; and
after a difference in the voltage values falls within a predefined range, operating switches that are electrically connected between the input capacitor and fuel cell stack to electrically connect the fuel cell stack with the battery.

9. The method of claim 8, wherein the operating includes selectively activating a field effect transistor.

10. The method of claim 8 further comprising, after the difference falls within the predefined range, disabling the flyback converter.

11. The method of claim 8 further comprising operating the DC-DC power converter to boost voltage from the fuel cell stack while the flyback converter is disabled.

12. The method of claim 11, wherein the operating the DC-DC power converter includes selectively activating a field effect transistor that shares a first node with an inductor of the DC-DC power converter and shares a second node with an output capacitor of the DC-DC power converter.

13. A power system for a vehicle comprising:
a DC-DC power converter configured to be selectively electrically connected between a fuel cell stack and battery of the vehicle, and including an input capacitor, an output capacitor, and an inductor electrically connected between the input and output capacitors;
a flyback converter isolated from the DC-DC power converter; and
one or more controllers programmed to operate the flyback converter to drive a voltage value of the input capacitor toward a voltage value of the fuel cell stack.

14. The power system of claim 13, wherein the power system further includes switches electrically connected between the fuel cell stack and input capacitor.

15. The power system of claim 14, wherein the one or more controllers are further programmed to close the switches after a difference between the voltage values falls within a predefined range.

16. The power system of claim 13, wherein the one or more controllers are further programmed to disable the flyback converter after a difference between the voltage values falls within a predefined range.

17. The power system of claim 16 wherein the one or more controllers are further programmed to operate the DC-DC power converter to boost voltage from the fuel cell stack while the flyback converter is disabled.

18. The power system of claim 17, wherein the DC-DC power converter includes a field effect transistor sharing a first node with the inductor and a second node with the output capacitor and wherein the one or more controllers are further programmed to operate the DC-DC power converter to boost voltage from the fuel cell stack via selective activation of the field effect transistor.
